(19) United States
(12) Patent Application Publication
(10) Pub. No.: US 2013/0165747 A1
(43) Pub. Date: Jun. 27, 2013

(54) SEXUAL STIMULATOR

(71) Applicant: Tony Maggs, Bangkok (TH)

(72) Inventor: Tony Maggs, Bangkok (TH)

(21) Appl. No.: 13/642,492

(22) PCT Filed: Apr. 19, 2011
(86) PCT No.: PCT/IB2011/051687

§ 371 Date: Feb. 19, 2013

(30) Foreign Application Priority Data
Apr. 19, 2010 (GB) 1006495.4

(51) Int. Cl. A61H 19/00; A61H 23/02

(52) U.S. Cl. CPC A61H 19/00; A61H 23/02
USPC 600/38; 601/46

(57) ABSTRACT

A sexual stimulator for providing sexual stimulation to a user comprises a housing (1), a moving part (7) housed within the housing so as to cause motion of at least part of the housing (1) so as, in use, to provide a user with sexual stimulation, and a control circuit (8) for the moving part in which the control circuit (8) is arranged so as to control the strength of the motion caused by the moving part (7), the control circuit being arranged so that, at a first moment of time, the control circuit (8) causes the moving part (7) to commence the motion at a first strength, and then causes the strength of the motion to increase over a first period of time in which the first strength is insufficient to wake a user. Thus, a user can be gently roused from sleep such that sexual stimulation can take place before the moment of waking, with a user waking up sexually stimulated.

This invention relates to a sexual stimulator.

Sexual stimulators, such as vibrators, are well known; in vibrators, a vibrating part is mounted within a housing which is pressed against a user's body (usually the genitalia) in order to provide sexual stimulation. Another type of sexual stimulator is a squirmer, which comprises a plurality of balls held within a usually phallically shaped sheath, which are moved by the relatively slow rotation (say one or two rotations every second) of an eccentric shaft. This can be inserted within an orifice of a user (for example, the vagina), where the movement of the balls within the sheath can stimulate pleasurable feelings. An example of a stimulator comprising both a vibrator and a squirmer is the Rampant Rabbit® sold by Ann Summers Limited.

United States Patent Application Publication US200910318753 discloses a vibrator with an integrated alarm clock. This activates the vibrator (or sounds an alarm) at a predetermined time, in order to remind a user to initiate sexual activity.

According to a first aspect of the present invention, there is provided a sexual stimulator for providing sexual stimulation to a user, comprising a housing, a moving part housed within the housing so as to cause motion of at least part of the housing so as, in use, to provide a user with sexual stimulation, and a control circuit for the moving part, in which the control part is arranged so as to control the strength of the motion caused by the moving part, the control circuit being arranged so that, at a first moment of time, the control circuit causes the moving part to commence the motion at a first strength, and then causes the strength of the motion to increase over a first period of time.

As such, a user can be gently roused, typically from sleep, by a gradually increasing motion; the increase may be continuous or quasi-continuous, or may be discrete and typically stepwise. Accordingly, sexual stimulation can take place before the moment of waking, with a user potentially waking up sexually stimulated.

Genital stimulation, for example, does not, of course, necessarily result in feeling sexually stimulated. Depending upon many factors, including mood, whether it is a workday or a weekend/holiday, and so forth, the genital stimulation will be interpreted by and reacted to in a variety of ways. While waking feeling sexually stimulated was the most common outcome, our user testing on women found that gentle genital stimulation that leads the user to experience the initial stimulation while still sleeping for a period of time then slowly waking over another period of time to slowly increasing stimulation can have a variety of non-sexual responses, including feeling sensual; feeling energised; feeling happy; feeling feminine. These feelings are sometimes in addition to and sometimes instead of feeling sexually stimulated.

Users often report a sense of joy to starting the day with such pleasure, erotic or otherwise, intense or mild, especially in contrast to the headsplitting unpleasantness of a conventional audible alarm clock. Further, the euphoria in many cases continues during the day, leading the users to feel an elevated sense of mood far beyond the mere morning, in much the same way that a morning run often results in feeling invigorated all day. The most common reaction has been waking feeling sexually stimulated, at times exceedingly sexually stimulated.

The first strength may be insufficient to wake a user, but may instead cause sexual arousal of the user. This may, for example, lead to erotic dreams or pleasant half-awake states.

Generally, the control circuit may determine the occurrence of the first moment of time. The control circuit may comprise a clock arranged to determine the current time, and be arranged such that it determines the occurrence of the first moment in time (and so commences the motion) by comparing the current time to a pre-determined time.

The housing may be sized and shaped so as to be placed on, in or about a user's erogenous zone. For example, the housing may be sized and shaped so as to be placed adjacent to the external genitalia of a male or a female. For an embodiment that is, in particular, appropriate for use by a female, the housing may be generally triangular in shape, typically with rounded vertices, and may be sized to fit conveniently over the crotch or pubic area. For example, in such a triangular shape, the sides of the triangle may each be no larger than 15, 12 or 10 cm. The device may fit within a user's underwear, and so may be at most 1, 2, 3, 4, 5, 7 or 10 cm thick.

In an alternative embodiment, the housing may be sized and shaped to be placed within an orifice of a user, for example the vagina or anus. In such a case, the housing may be generally cylindrical, typically with a rounded end for ease of insertion. The housing may be so shaped so as to remain within the orifice; for example, it may have a ridge towards one end—typically distal from the rounded or insertion end—by means of which the wearer's muscles will hold onto the housing.

In a further alternative, suitable for use by males, the housing could define an orifice sized and shaped to accept a user's penis, typically lined with or formed of a resilient material that can retain a penis overnight whilst the penis varies in turgidity.

For whichever embodiment is employed, the housing may be provided with straps to hold the housing in place.

The stimulator may also comprise a strength control manipulatable by a user, the strength control being connected to the control circuit so that the user can adjust the strength of the motion. Thus, once the user is sufficiently awake to decide how strong they would like the motion to be, they can adjust those to the most appropriate level. The stimulator may also comprise an initial strength control manipulatable by a user, the initial strength control being connected to the control circuit such that the user can select the first strength. Thus, a user can, on the basis of, for example, whether they are a heavy or light sleeper, select the initial strength of the motion with which they are presented.

The control circuit may be mounted in the housing. Alternatively, the stimulator may comprise a control housing in which at least one of the control circuit and any controls are mounted. The control housing and the housing may be directly connected by wires, or may be connected by wireless technologies such as radio, Bluetooth, local area network, internet or GSM, WCDMA or other wireless telephony system.

The stimulator may comprise an audible sounder, connected to the control circuit; the control circuit may then be arranged to sound an alarm at an alarm time. The alarm time may be separately set by a user, or may be determined as a delay from the pre-determined time. The alarm time may come after the end of the first period of time.

The first period of time, over which the strength of the motion increases, may be at least one minute, two minutes, five minutes or ten minutes.

The stimulator may comprise a sleep state sensor for determining the sleep state of a user; the control circuit may take the output of the sleep state sensor and use this to determine the occurrence of the first moment of time. For example, the sleep state sensor may determine when a user has entered rapid eye movement (REM) sleep, and the control circuit may determine the occurrence of the first moment of time (and so commence the motion) when the user enters REM sleep.

The sleep state sensor may comprise a sensor for movement of the user's eyes, typically in the form of an eyemask. Alternatively or additionally, the sleep state sensor may comprise any or all of:
a sound sensor arranged to determine from the noises made by a user their sleep state;
a heart rate monitor arranged to measure the user's heart rate;
an erection sensor arranged to determine whether the user's penis is erect; typically, this may comprise a pressure sensor arranged to sense the pressure on the sensor of an erect penis.

Particularly where the sleep state sensor is employed, the control circuit may be arranged so as to continue the motion for only a second period of time. The second period of time will typically be longer, or co-extensive, with the first period of time. Where the sleep state sensor is employed, the control unit may determine the second period of time dependent upon the output of the sleep state sensor; for example, the second period of time may be the period of time whilst a user is in REM sleep.

The control circuit may comprise a memory for the sleep patterns of the user. As such, the control circuit may record in the memory the sleep states of the user; the control circuit may then be capable of being trained to predict when the user will change sleep state, and to make the first or second period of time finish before such a change. For example, the control circuit may record in the memory the length of time that the user remains in REM sleep, and set the second period of time to be shorter (usually only slightly shorter, say by at most 10%) than the length of time that the user remains in REM sleep.

The control circuit may also be arranged to record in the memory the strength of the motion at which the user changed sleep state, for example by leaving REM sleep. Thus, the control circuit can be trained to not increase the strength of the motion past the limit where the user exits REM sleep.

The control circuit may be arranged so as to increase the strength of the motion when a user exits REM sleep, so as to bring them to wakefulness; typically, the user will then be in a sexually aroused waking state.

In a further embodiment, the control circuit is arranged to determine the occurrence of the first moment in time by determining the sleep state of the user and determining from the clock whether the present time is within a predetermined window.

The sexual stimulator may be provided with a manual override coupled to the control circuit such that the user can select the manual override in order to cause the control unit to cause the motion to commence. This allows the user to use the device without waiting for the first moment of time. However, the control unit may be provided with an inhibited mode, whereby the control circuit will not cause the motion to commence until the first moment in time regardless of whether the manual override is selected, and an uninhibited mode, in which selection of the manual override will cause the control unit to cause the motion to commence.

Selection of the manual override may cause the control circuit to cause the motion for a pre-determined period of time, or until the sleep state sensor indicates that the user is asleep. Accordingly, the device may gently sooth a user to sleep.

The sexual stimulator may comprise a vibrator, whereby the moving part comprises a vibrating part arranged to vibrate at least part of the housing. Alternatively or additionally, the sexual stimulator may comprise a squirmer, whereby the housing comprises a flexible sheath and a plurality of balls held within the sheath, the moving part comprising an eccentric shaft positioned within the balls.

The moving part may comprise a motor, typically with a weight eccentrically mounted on an output shaft thereof. However, in one embodiment, the sexual stimulator comprises a plurality of motors, which would typically each have a weight eccentrically mounted on an output shaft thereof. The weights may have different masses. The motors may have different maximum speeds for a given input voltage.

This embodiment can have several advantages. Firstly, by using two motors, a great range of speed, and so strength of motion can be achieved, as either or both motor can be used. This allows a wide range of strengths to be achieved, typically as a smooth continuum. Secondly, the vibrations of the two motors need not be occurring at the same speed or frequency, and so interference may occur. This interference, at the beat frequency (the difference between the frequencies of the vibration of each motor) will be experienced by a user as a pleasurable throbbing.

The sexual stimulator may comprise a flexible resilient sheath at least partially surrounding the housing. The sheath may be waterproof and so prevent the ingress of bodily fluids into the housing; the sheath may partially surround the housing, typically so as to prevent the ingress of bodily fluids into a sensitive area of the housing, or may completely surround the housing. The sheath may be provided with an external surface comprising a plurality of nubs extending away from the housing; this may provide a particularly arousing feeling when the motion is commenced. The sheath may be removable and replaceable; this means that sheaths can be interchangeable, so that a user can tailor the feel of their stimulator to their particular preferences, and also for easy cleaning of the sheath.

Where we refer to the strength of the motion, the strength can comprise the amplitude, speed, movement range (angular or linear) or frequency of movement of the moving part, or any other characteristic that translates to a different level of feeling for the user.

According to a second aspect of the invention, there is provided a method of using a sexual stimulator so as to stimulate, typically sexually, a user, the sexual stimulator comprising a housing, and a moving part housed within the housing so as to cause motion of at least part of the housing;
the method comprising placing the stimulator against a user's body, commencing the motion at a first moment of time and at a first strength, and then increasing the strength of the motion over a first period of time, the commencement of the motion and the increasing of the strength occurring without manual intervention by the user at the first moment in time and over the first period of time respectively.

As such, a user can be gently roused, typically from sleep, by a gradually increasing motion. Accordingly, sexual stimulation can take place before the moment of waking, with a user potentially waking up sexually stimulated.

The first strength may be insufficient to wake the user, but may instead cause sexual arousal of the user. This may, for example, lead to erotic dreams or pleasant half-awake states.

Generally, the method may comprise determining, in the sexual stimulator, the occurrence of the first moment of time. The determination of the first moment of time may comprise comparing the current time to a pre-determined alarm time; typically, the first moment of time will be determined if the current time is the same as the pre-determined alarm time.

The housing may be sized and shaped so as to be placed on, in or about a user's erogenous zone. For example, the housing may be sized and shaped so as to be placed adjacent to the external genitalia of a male or a female. For an embodiment that is, in particular, appropriate for use by a female, the housing may be generally triangular in shape, typically with rounded vertices, and may be sized to fit conveniently over the crotch or pubic area. The method may therefore comprise placing the housing within the user's underwear, or attaching it to or inserting within an orifice of the user, before the first moment in time.

The method may comprise the user manipulating a strength control so as to adjust the strength of the motion. Thus, once the user is sufficiently awake to decide how strong they would like the motion to be, they can adjust the strength of the motion to the most appropriate level. The method may also comprise the user selecting the first strength, typically before the first moment in time. Thus, a user can select whether, for example, they are a heavy or light sleeper, and accommodate for this fact with the initial strength of the motion with which they are presented.

The method may comprise the sexual stimulator sounding an alarm at an alarm time. The alarm time may be separately set by a user, or may be determined as a delay from the pre-determined time. The alarm time may come after the end of the first period of time.

The first period of time, over which the strength of the motion increases, may be at least one minute, two minutes, five minutes or ten minutes.

The method may comprise determining the sleep state of a user; this may be used to determine the occurrence of the first moment of time. For example, first moment in time may be determined when a user has entered rapid eye movement (REM) sleep.

The method may comprise continuing the motion for only a second period of time. The second period of time will typically be longer, or co-extensive, with the first period of time. The second period of time will generally be determined by the sexual stimulator, and may be dependent upon the sleep state of the user; for example, the second period of time may be the period of time whilst a user is in REM sleep.

The method may comprise recording the sleep states of the user; the sexual stimulator may then be trained to predict, and may so predict, when the user will change sleep state, and to make the first or second period of time finish before such a change. For example, the sexual stimulator may record the length of time that the user remains in REM sleep, and set the second period of time to be shorter (usually only slightly shorter, say by at most 10%) than the length of time that the user remains in REM sleep.

The sexual stimulator may also record the strength of the motion at which the user has changed sleep state, for example by leaving REM sleep. Thus, the method can comprise training the sexual stimulator not to increase the strength of the motion past the limit where the user exits REM sleep.

The method may comprise increasing the strength of the motion when a user exits REM sleep, so as to bring them to wakefulness; typically, the user will then be in a sexually aroused waking state.

The method may also comprise determining the occurrence of the first moment in time by determining the sleep state of the user and determining from whether the present time is within a predetermined window.

The sexual stimulator may comprise a vibrator, whereby the moving part comprises a vibrating part arranged to vibrate at least part of the housing. Alternatively or additionally, the sexual stimulator may comprise a squirmer, whereby the housing comprises a flexible sheath and a plurality of balls held within the sheath, the moving part comprising an eccentric shaft positioned within the balls.

The method may comprise the use of the sexual stimulator of the first aspect of the invention.

According to the third aspect of the invention, there is provided a sheath for a vibrating device, the sheath being flexible and resilient and arranged to at least partially encompass the vibrating device in a waterproof manner, the sheath being provided with a plurality of nubs on an external surface of the sheath for stimulating a user when the vibrating device vibrates within the sheath. The sheath may partially surround the vibrating device, typically so as to prevent the ingress of bodily fluids into a sensitive area of the housing, or may completely surround the housing.

The nubs may comprise ridges or protrusions. The sheath may be arranged to completely encompass the device, so that water or bodily fluids cannot reach the device from outside the sheath; there will typically be no holes in the sheath. The nubs may cover the entire external surface of the sheath.

The vibrating device may be a mobile telephone or other hand-held device; it will typically not be possible to operate all of, or potentially any of, the communications functions of the device whilst it is in the sheath.

According to a fourth aspect of the invention, there is provided a vibrating device sheathed by the sheath of the third aspect of the invention.

According to a fifth aspect of the invention, there is provided a computer program for a hand-held computing device comprising a vibrating member, the computer program being arranged to control the vibrating member such that the device operates as the sexual stimulator of the first aspect of the invention or according to the method of the second aspect of the invention. Typically, the device will be a mobile telephone.

There now follows, by way of example only, embodiments of the present invention, described with reference to the accompanying drawings, in which:

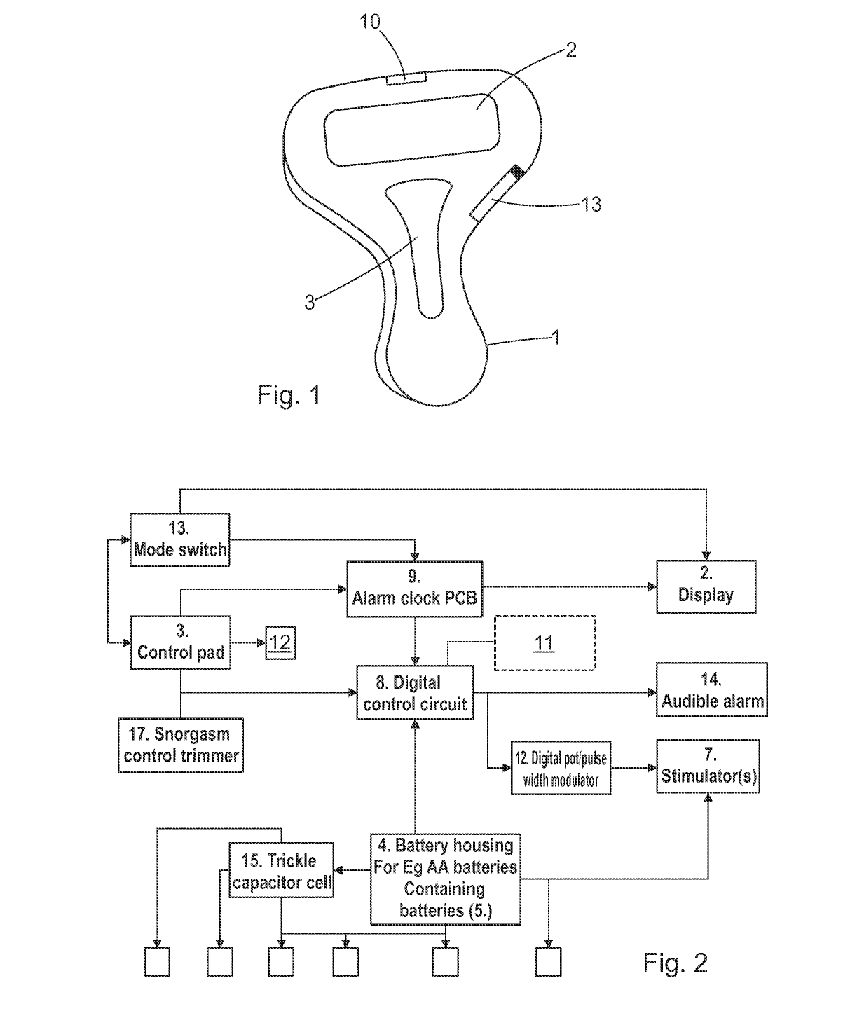

FIG. 1 shows a perspective view of a sexual stimulator according to a first embodiment of the invention;

FIG. 2 shows a schematic view of the internal circuitry of the sexual stimulator of FIG. 1;

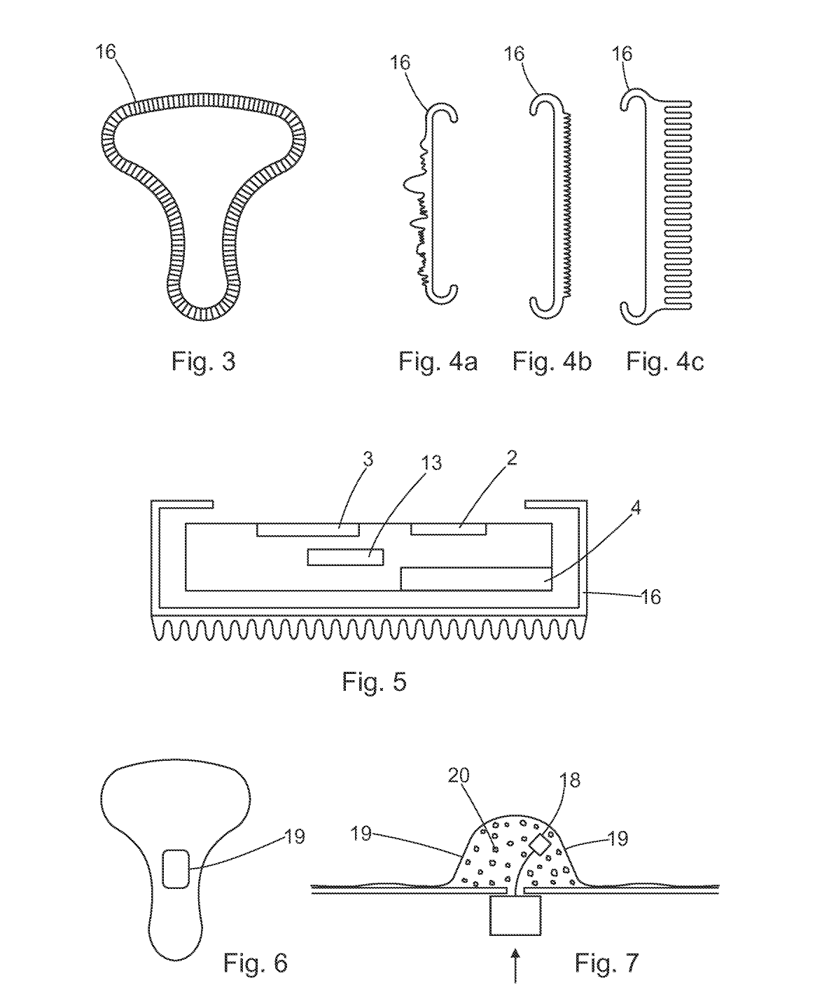

FIG. 3 shows a plan view of a sheath used with the sexual stimulator of FIG. 1;

FIGS. 4a to 4c show side elevations of different embodiments of the sheath of FIG. 3;

FIG. 5 shows a cross section through the sexual stimulator of FIG. 1, surrounded by the sheath of FIG. 3;

FIG. 6 shows a sexual stimulator according to an additional embodiment of the invention;

FIG. 7 shows a cross section through the sexual stimulator of FIG. 6;

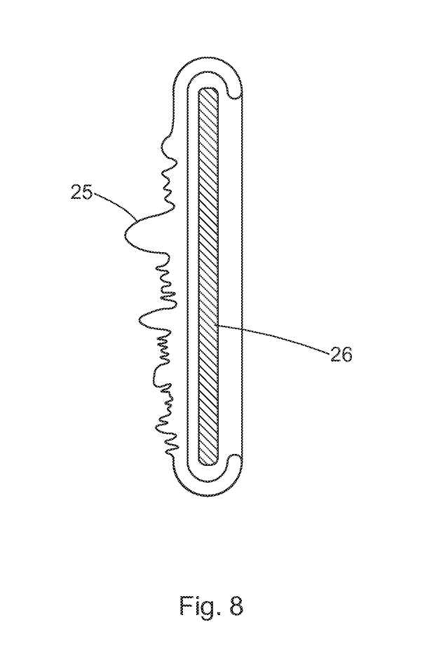

FIG. 8 shows a cross section through a sheathed mobile telephone operating as a sexual stimulator according to a further embodiment of the invention;

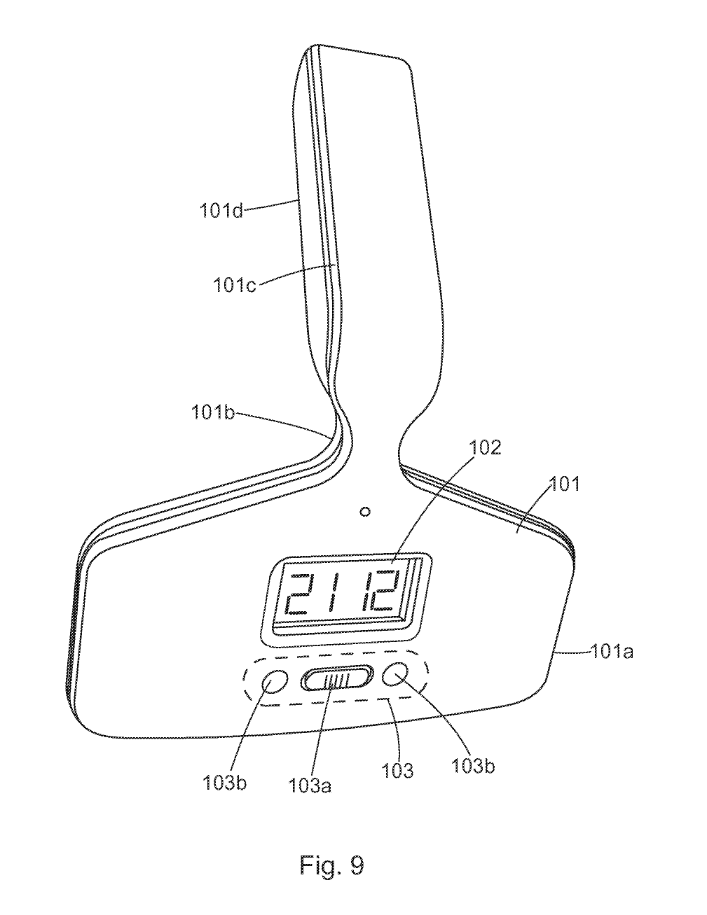

FIG. 9 shows a perspective view of a sexual stimulator according to a second embodiment of the invention; and

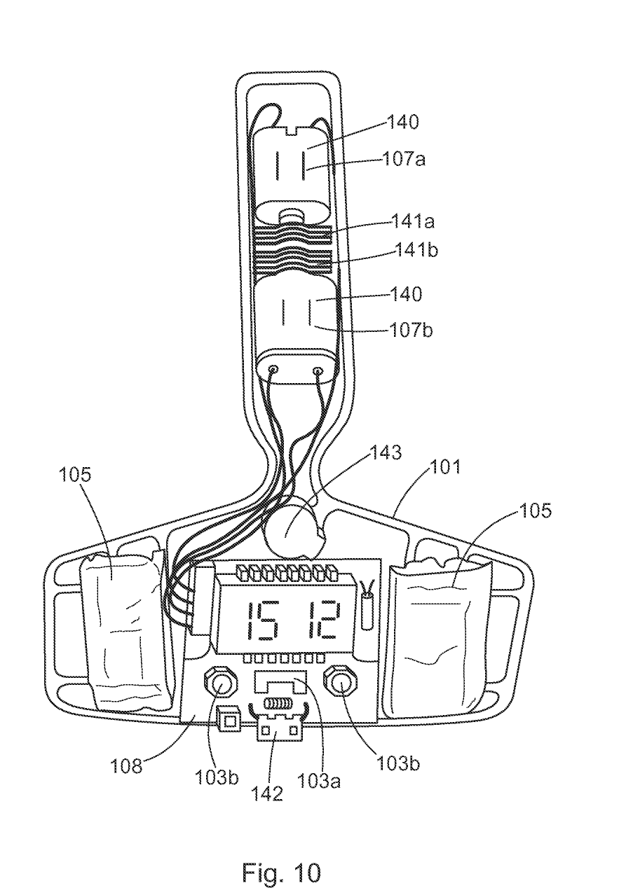

FIG. 10 shows a plan view of the sexual stimulator of FIG. 9, with the top half of the housing partially removed.

A sexual stimulator according to a first embodiment of the invention is shown in FIGS. 1 to 5 of the accompanying drawings. It comprises a housing 1. That housing is provided with a display 2 (which can show the time or other such information required to operate the device), a control panel 3 used to activate the features of the sexual stimulator described below and a battery housing 4 into which batteries 5 (either rechargeable or single-use; typically standard AA size) can be inserted.

The housing 1 is generally triangular in shape, with curved contours to fit against a woman's crotch, and is sized such that it can be placed within (typically a female) user's underwear, where it will be held against the user's genital area. The face bearing the control panel 3 and display 2 is convex, and the opposite face concave, so as to snugly fit the concave side against the user's body.

The internal features within the housing 1 of the sexual stimulator are shown in more detail in FIG. 2 of the accompanying drawings. This shows that the batteries 5 power the other features of the sexual stimulator; the batteries will be provided with a trickle-charge capacitor 15, which will power at least some of the functions of the device (for example, the clock) should the power in the batteries fail.

A moving, vibrating part 7 is provided, which comprises a motor with a load that is off-centre with respect to the axis of the motor's output shaft. Thus, when the motor runs, the centre of gravity of the vibrating part will rapidly oscillate, producing a vibrating motion. The vibrating part 7 is controlled by a control circuit 8, which controls the supply of current from the batteries 5 to the vibrating part 7 through a digital potentiometer or pulse width modulating unit 12, and so can control both whether the vibrating part 7 vibrates, and the amplitude and speed or frequency (and so the strength) of the vibrations with which it vibrates, by modulating the speed of the motor.

In addition, a clock circuit 9 is provided, which indicates the current time and outputs the same to the control circuit 8. The control circuit 8 is also connected to the display 2 and the control panel 3.

A mode switch 13 is also provided, which allows the selection of different modes of operation of the device as described below. The selected mode can be displayed on the display 2.

The control panel 3 can be used to select the various functions of the device. Preferably, the control panel 3 comprises a plurality of recessed buttons, so as to avoid the buttons being inadvertently pressed whilst the user is asleep.

In this embodiment, the clock circuit 9 is programmed by a user with a target time when they want to be gently awoken in an erotic manner. The user uses the control panel 3 to achieve this; whilst the user is programming this time the display 2 will indicate the target time, but once that programming is completed the display 2 will revert to showing the current time.

Once the user has so programmed the target time, they can place the sexual stimulator in their underwear and go to sleep.

The control circuit 8 continually or regularly or increasingly frequently as the target time approaches compares the current time from the clock 9 with the target time. Once the target time is reached, it will commence the vibrating part vibrating at a relatively low amplitude. Typically, this will be insufficient to wake the user. However, given that the housing is held against the wearer's genital area then, presuming a female user, the vibrations will be passed from the vibrating part 7 through the housing to the genital area, thus stimulating the user's sensitive parts in that area, such as the clitoris or labia.

Over a following period of time—referred to as the first period of time—the control unit 8 will gradually increase the amplitude of the vibrations, without any input from the user (who may well be, it should be remembered, asleep). Given the gentle start and gradual increase to the vibrations, the user may experience pleasant sexual dreams or pleasurably half-asleep states, and then be gradually awoken from sleep with a pleasantly aroused feeling.

The control unit 8 will continue to increase the amplitude and speed of the vibrations throughout the first period of time. At the end of this period, typically one, two, or five to ten minutes, the vibrations may cease, in which case a second period of time in which the vibrations are active will be co-extensive with the first period of time. Alternatively, the vibrations may continue at a maximum amplitude after the first period of time has ended; in such a case, the second period of time will be longer than the first, say twenty minutes. Alternatively or additionally, after the first period of time, the amplitude of the vibrations may decrease, or repeated decrease and increase, typically in a pre-programmed pattern, the pattern being pre-set in the device or pre-programmed by the user.

An audible alarm 14 can be provided that can sound at the end of the first or preferably the second period of time, to remind a user to get up. The audible alarm 14 can also sound if the batteries 5 are sensed by the control circuit 8 to be depleted to the level where they can no longer run the vibrating part 7. A low battery warning can also be displayed on the display 2 in such a case. Information as to the level of charge in the batteries 5 can be displayed on the display 2; alternatively, the user can be warned using the display 2 when setting the alarm that there is insufficient charge in the batteries 5 to perform the selected alarm function.

The mode switch 13 may cause the device to have the following modes:
1. Off: The device is powered down, but the clock circuit 9 keeps track of the passage of time.
2. Set alarm and clock: Allows the setting of the alarm and present time.
3. Alarm on mode 1: The stimulator functions as described above, in that the control circuit 8 waits until the alarm time is reached, then starts the vibrator 7 moving at a low speed, gradually increasing the speed over the first period of time.
4. Alarm on mode 2: As for Alarm on mode 1, but increases the speed of the motion more quickly.
5. Alarm on mode 3: As for Alarm on mode 2, but with a higher initial speed of motion.
6. Alarm on mode 4: As for Alarm on mode 1, but with a higher initial speed of motion.
7. Alarm on mode 5: As for Alarm on mode 1, but the user determines the initial speed of motion and the rate at which the speed of the motion increases.
8. Play: Control circuit immediately starts vibration at low amplitude (or continues vibration at present amplitude if already commenced).

In the “alarm on” modes, one of the buttons of the control panel 3 will act to “snooze” the device, in that the vibrations will cease for a pre-determined period of time of, say, 9 minutes; this will allow the user to return to sleep if they so desire.

Another button will act as to initiate a “snorgasm” function (a portmanteau term combining “snooze” and “orgasm”), where the vibrations are held at a low level for a pre-determined period (say 9 minutes), before gradually increasing once more. This allows the user to enjoy low level stimulation and the arousal associated therewith before eventually being fully woken by the increased levels of vibration. A trimmer 17 is provided, typically concealed by the batteries 5, whereby the amplitude of the low level vibrations can be set according to a user's preferences; alternatively, this could be set using the control panel 3.

In the play mode, the buttons of the control panel 3 will allow the user to increase or decrease the level of vibrations as they see fit.

The stimulator is provided with a sheath 16, formed of a flexible resilient non-toxic material such as silicone or silicone jelly. FIG. 3 shows the overall shape of the sheath, whereas FIGS. 4a to 4c show different examples of the external profile of the sheath. The sheath 16 has several functions. Firstly, it is waterproof and protects the device, especially the mode switch 13, the port 10 and the batteries 5, from the ingress of bodily fluids. Secondly, it can easily be removed and washed, thus making the device particularly hygienic. Thirdly, it is designed to be physically stimulating; the external profile of the sheath comprises a plurality of nubs, so as to increase the pleasure given by the unit. Fourthly, the sheath can be changed, so as to change the appearance and feel of the stimulator, allowing the user to tailor the stimulator to their particular preferences. FIG. 5 shows the stimulator safely received within its sheath 16.

Whilst the present embodiment is of the form that is suitable for external use by female users, the embodiment could be extended to any suitably shaped or sized device. Rather than being worn in the user's underwear, the device could be secured by straps to the user. The device may be sized and shaped so as to fit into a user's orifice, such as a vagina or anus. In such a case, the housing may be generally cylindrical and elongate, with rounded ends, in the manner of a dildo. Alternatively, the housing could be of the form of a squirmer, as explained in the introduction above.

A version for male users could define a hollow tube into which the user could insert their penis; the tube would typically be made of a soft, pliable material such as silicone, with nodules on the interior to engage the penis, the vibrations being passed through the nodules to stimulate the penis.

An alternative embodiment of a stimulator according to the present invention is shown in FIGS. 6 and 7 of the accompanying drawings. In this, rather than having an internal vibrating part 7, the device has, as its stimulating feature, a squirmer. In this embodiment, the moving part comprises an eccentric rod 18, contained within a flexible envelope 19 formed typically of silicone. The envelope 19 contains a plurality of small plastic ball bearings 20. Rotation of the eccentric rod 18 will cause the ball bearings 20 to move within the envelope 19, and so will move the envelope also. Thus, the user can be stimulated.

The housing 21 of this embodiment is of similar shape to that of the previous embodiment, except that the envelope 19 is mounted on the face of the housing 21 which is pressed against the user's genitalia. As can be appreciated, the present invention is not limited by the precise means by which the user is stimulated.

Furthermore, whilst the control circuit is shown as mounted within the same housing as the vibrating part, it need not be. A remote housing may house the control circuit, and any other of the integers other than the vibrating part. The two housings may be connected by wires, or by remote means such as radio waves. The remote housing may comprise a charging station for the battery of the housing housing the vibrating part. A cleaning device, such as an ultrasonic cleaning device, may be provided, for example in the remote housing.

In an extension to the first embodiment above, the device of FIGS. 1 to is further provided with a sleep-state sensor 11, shown in FIG. 1 as optional by means of its dotted lines which detects whether a user is awake or asleep. Such a sleep-state sensor 11 can determine whether the user is asleep by detecting eye movement; the eyemask used in U.S. Pat. No. 5,507,716 (the disclosure of which is hereby incorporated herein by reference) could be used for example.

Alternatively, the sleep-state sensor 11 could be a sensor for the noises made by a sleeping user, as described in PCT Patent Application publication number WO2008/098943 (the disclosure of which is hereby incorporated by reference). In a further alternative, the sleep-state sensor 11 could comprise a heart rate sensor.

The sleep-state sensor 11 could be internal to the housing 1 and directly connected to the control circuit 8, or could be external thereto and connected through port 10 to the control circuit 8. Port 10 can also be used to program the stimulator, or to recharge the batteries 5, where rechargeable batteries are used.

In this embodiment, once the control circuit detects that the sleep-state sensor 11 indicates that the user has entered rapid eye movement (REM) sleep (the period of sleep in which dreams are had), it will gently commence vibrating (and so commence the first and second periods of time). The vibrations are gentle enough to stimulate the user in the hope that they dream erotically, but not sufficiently strong to wake the user. They will gradually increase in amplitude.

The first or second periods of times may be limited to, say, five minutes. Alternatively, the control circuit may end the vibrations when REM sleep is left and other periods of sleep commenced. In a particularly advantageous embodiment, the control circuit 8 records in memory forming part of the control circuit 8 the user's sleep patterns as determined by the sleep-state sensor 11 (for example, records or eye movement or heart rate against time). From this, the control unit can determine how long the user generally remains in REM sleep, and set the first or second period of time to be that length.

The user may command, using the control panel 3, that they wish to be woken from REM sleep, with the hope that they wake from an erotic dream. This can be achieved by not stopping vibrations when the end of REM sleep is detected; indeed the vibrations can be gently or sharply increased in amplitude when that occurs. The user may then be in a sexually aroused waking state. The user can also specify a window time in which they wish to be woken from an REM state (for example, around the time that the user would normally wake, such that they specifically wake in an aroused state when that possibility arises).

The control circuit 8 may also record in the memory the amplitude of vibrations that the user has endured without waking. As such, the control circuit 8 can increase the vibrations night-on-night to find the maximum amplitude that will not wake the user, to prolong their enjoyment of the device. The user can also indicate whether they are a heavy, medium or light sleeper, which may be reflected in the initial amplitude of vibrations.

The port 10 may be used to upload user-defined wake up sequences to the stimulator, whereby the user can select a profile of vibration amplitude against time with which they desire to be woken up.

For hygiene's sake, the above embodiments may be formed of waterproofed or otherwise sealed units, although this is less important if a sheath is employed.

In a further embodiment of the invention shown in FIG. 8 of the accompanying drawings, a sheath 25 similar to those of FIGS. 3 and 4 could be used to sheath a mobile telephone 26 or other hand-held computing device having a vibrating function. If suitable programming is loaded onto the sheathed device, the user can enjoy the gradually increasing vibrations given by the device in a manner according to the present invention.

A sexual stimulator according to a second embodiment of the invention is shown in FIGS. 9 and 10 of the accompanying drawings. In this embodiment, features common to the embodiment of FIG. 1 have been given corresponding reference numerals, raised by 100. The sexual stimulator of this embodiment is designed to be used by adult females, and to be worn overnight, so that the user wakes up in a pleasant fashion.

The sexual stimulator of this embodiment comprises a housing 101 with a display 102. A control panel 103 comprises switch 103a and two buttons 103b.

The housing 101 comprises three portions. The first portion 101a sits, in use, over the user's pubic bone area and contains the display 102 and control panel 103. The second portion 101b is of the form of a narrow neck, joining the first portion 101a to an elongate third portion 101c.

The narrow shape of the second portion 101b helps the device be kept in place as the user sleeps.

The elongate third portion 101c will be held in use against the user's genital area between the user's legs. The third portion has a flat underside 101d, so as to touch as much of the user's genital area as possible, and so provide a general pleasant sensation, rather than stimulating one particular area.

FIG. 10 shows the internal components of the stimulator, with the top half of the housing 101 removed; these components would not normally be accessible to a user as the housing 101 is sealed. In this embodiment, two rechargeable batteries 105 are provided. The batteries 105 are charged by inserting the plug of an external charger into a socket 142 in the stimulator. A control circuit 108 controls the various functions of the stimulator, and additionally provides a buzzer 143 arranged to beep on demand.

Two vibrating parts 107a, 107b are provided within the housing, each comprising a motor 140 and an eccentric weight 141a, 141b. The eccentric weights 141a and 141b are of differing masses, weight 141b being bigger, such that the effect that they have on the overall strength of vibration differs for the same motor speed.

With the switch 103a in a first position, the user can set the time, alarm time, initial power, peak power, snooze power and duration of alarm sequence using the buttons 103b. The alarm sequence can also be triggered by holding one of the buttons down for four seconds, as can a fast run-through of the alarm sequence (60 times as fast as normal) for test and checking purposes by holding down the other button for four seconds.

The alarm is set by turning the switch 103a to a second position. Until the set alarm time, neither of the buttons 103b have any effect so nothing can be accidentally triggered during sleep.

At alarm time, the alarm sequence starts very gently at initial power for two minutes, using just the gentler of the two vibrating parts 107a (that is that with the smaller eccentric weight 141a). The intensity is increased by increasing the speed of the motor 140 of the vibrating part 107a, and adding the other vibrating part 107b and modulating the speed of the two vibrating parts 107a, 107b together.

The intensity of the vibrations is slowly increased until reaching the set peak power in the set alarm duration (between 1 and 9 minutes), then for nine minutes at peak intensity. If one of the buttons 103b is pressed, the stimulator ‘snoozes’ or switches off for 9 minutes, after which it starts again. If the other of the buttons 103b is pressed, the stimulator vibrates at set, usually very gentle, snooze power for 9 minutes and then starts the alarm sequence again.

At the end of the alarm sequence the stimulator beeps for 30 seconds to ensure that the user is awake, then if left alone the motors 140 are turned off and the alarm is set for the same time the following day.

If the duration of alarm sequence is set at zero, the stimulator works as a conventional alarm clock, beeping at alarm time; in this case, both buttons work as snooze buttons.

With the switch 103a in a third position, the stimulator works as a standard vibrator, with one of the buttons 103b increasing the intensity of vibrations and the other one of the buttons 103b decreasing it along a continuum. The lower power settings involve, in order of increasing intensity of vibration: only the least powerful vibrating part 107a being switched on at its lowest speed setting; the intensity due to that vibrating part 107a increasing; then both vibrating parts 107a and 107b being turned on at their lowest speed settings, then increasing the speed of the motor 140 of each vibrating part 107a, 107b.

As such, this provides a continuum of intensity, perceived by the user as being smooth, albeit with the quality of the vibration changing when the motors change from one motor to two and vice versa. This changing quality of vibration is perceived by many users as giving the stimulator a high quality, ‘classy’ aspect. Users can enjoy the throbbing, pleasurable interference of having two motors: by first having only one motor vibrate the user can experience a variety of qualities of vibration by having one and two motors vibrating sequentially.

At any given time the control circuit 108 measures the voltage output of the batteries 105 and uses the measured voltage to determine the battery charge level. When the voltage falls very low (when there is, say 10% or 5% charge left) the stimulator goes into ‘low battery’ mode, where it acts purely as a clock and to retain the user's settings.

If the battery charge level reaches this threshold during the alarm sequence, the stimulator beeps to ensure that the user wakes, will react to one of the buttons 103b being pressed by ceasing to beep and then continue to act purely as a clock and to retain the user's settings. Pressing any of the buttons 103b or using the switch 103a has no effect in this mode.

Furthermore, the battery level is used to make the power provided to the motors 140 independent of battery charge level. In order to maintain the same power output irrespective of the charge state of the battery, the voltage is measured and the power output is multiplied by a factor of

$$\frac{( full battery voltage )}{( current battery voltage )} .$$

This allows the stimulator to be set to start at a power output only slightly higher than that required to run the motors 140: without this feature, when the batteries 105 were low, the motors 140 may not start, which would be undesirable, be bad for the control circuit 108 and the motors 140 as well as wasting electricity.

Unlike most sex toys on the market, PWM (pulse width modulation) is used, rather than a variable resistor, to vary the intensity of the stimulation. The advantages of this include less power waste, longer battery life and less heat produced (eco-friendly).

The device has an initial vibration level that is settable to be very low, so that the user can sleep through the first period of the vibration. Both vibrating parts 107a, 107b can vibrate at a fairly strong level, in order to provide intense stimulation. The present embodiment achieves this by using vibrating parts 107a and 107b of differing strengths, which together can achieve the desired stimulation.

When starting a motor 140 from rest, in order to allow a low initial vibration level the stimulator uses an initial jolt at a fairly low power level, but one at which the motor 140 is certain to start, and which lasts for a fraction of a second. This jolt is so short, and at such a low level, that it is not perceived, or hardly perceived, by the user.

Similarly to ensure that the motors 140 do not grind to a halt as a result of the user moving suddenly in an inopportune way when the power output is at a low level which is strong enough to continue the motor moving, but not strong enough to start it, the control circuit 108 sends pulses of the duration of a fraction of a second of a voltage large enough to start the motor 140 every five or ten seconds while output is at these levels regardless of whether it is at rest. So long as these do not produce noticeable jolts, it allows the lowest power level to be very low indeed, without the risk of the motor switching off for more than a few seconds at most.

1. A sexual stimulator for providing sexual stimulation to a user, comprising a housing, a moving part housed within the housing so as to cause motion of at least part of the housing so as, in use, to provide a user with sexual stimulation, and a control circuit for the moving part, in which the control circuit is arranged so as to control the strength of the motion caused by the moving part, the control circuit being arranged so that, at a first moment of time, the control circuit causes the moving part to commence the motion at a first strength, and then causes the strength of the motion to increase over a first period of time, in which the first strength is insufficient to wake a user.

2. The sexual stimulator of claim 1, in which the control circuit determines the occurrence of the first moment of time.

3. The sexual stimulator of claim 1, comprising a strength control manipulatable by a user, the strength control being connected to the control circuit so that the user can adjust the strength of the motion.

4. The sexual stimulator of claim 1, comprising an initial strength control manipulatable by a user, the initial strength control being connected to the control circuit such that the user can select the first strength.

5. (canceled)

6. The sexual stimulator of claim 1, comprising a sleep state sensor for determining the sleep state of a user, the control circuit being arranged so as to take the output of the sleep state sensor and use this to determine the occurrence of the first moment of time.

7. (canceled)

8. The sexual stimulator of claim 1, in which the control circuit is arranged so as to continue the motion for only a second period of time.

9. The sexual stimulator of claim 8, in which the second period of time is longer, or co-extensive, with the first period of time.

10. The sexual stimulator of claim 8, in which the control circuit is arranged to determine the second period of time dependent upon the output of the sleep state sensor.

11-14. (canceled)

15. The sexual stimulator of claim 1, in which the control circuit is arranged to determine the occurrence of the first moment in time by determining the sleep state of the user and determining from the clock whether the present time is within a predetermined window.

16. The sexual stimulator of claim 1, provided with a manual override coupled to the control circuit such that the user can select the manual override in order to cause the control circuit to cause the motion to commence.

17. The sexual stimulator of claim 16, in which the control circuit is provided with an inhibited mode, whereby the control circuit will not cause the motion to commence until the first moment in time regardless of whether the manual override is selected, and an uninhibited mode, in which selection of the manual override will cause the control circuit to cause the motion to commence.

18. The sexual stimulator of claim 1, in which the moving part comprises a plurality of motors.

19. The sexual stimulator of claim 18, in which each motor has a weight eccentrically mounted on an output shaft thereof, the weights having different masses.

20. A method of using the sexual stimulator so as to stimulate a user, the sexual stimulator comprising a housing, and a moving part housed within the housing so as to cause motion of at least part of the housing;
the method comprising placing the stimulator against a user's body, commencing the motion at a first moment of time and at a first strength, and then increasing the strength of the motion over a first period of time, the commencement of the motion and the increasing of the strength occurring without manual intervention by the user at the first moment in time and over the first period of time, respectively, in which the first strength is insufficient to wake the user.

21. The method of claim 20, in which the vibrations at the first strength, instead of waking the user, causes sexual arousal of the user.

22. The method of claim 20, in which the step of placing the stimulator against the user's body comprises placing the stimulator against the external genitalia of the user.

23. The method of claim 20, comprising determining, in the sexual stimulator, the occurrence of the first moment of time.

24. (canceled)

25. The method of claim 20, comprising the user selecting the first strength before the first moment of time.

26-39. (canceled)

40. A computer program for a hand-held computing device comprising a vibrating member, the computer program being arranged to control the vibrating member such that the device operates according to the method of claim 20.

41. The computer program of claim 40, in which the device is a mobile telephone.
